(19) United States
(12) Patent Application Publication
(10) Pub. No.: US 2026/0286494 A1
(43) Pub. Date: Sep. 24, 2026

(54) Multicomponent Coating

(71) Applicants: Pratt & Whitney Canada Corp., Longueuil (CA); Concordia University, Montreal (CA); The Royal Institution for the Advancement of Learning/McGill University, Montreal (CA)

(72) Inventors: Bruno César Noronha Marques de Castilho, Montreal (CA); Joël Larose, Longueuil (CA); Mary E. Makowiec, Manchester, CT (US); Pantcho P. Stoyanov, Beaconsfield (CA); Christian Moreau, Boucherville (CA); Navid Sharifi, Verdun (CA); Richard Chromik, Montreal (CA)

(73) Assignees: Pratt & Whitney Canada Corp., Longueuil, QC (CA); Concordia University, (US); The Royal Institution for the Advancement of Learning/McGill University, Montreal, QC (CA)

(21) Appl. No.: 18/619,092

(22) Filed: Mar. 27, 2024

Related U.S. Application Data
(60) Provisional application No. 63/455,532, filed on Mar. 29, 2023.
(60) Provisional application No. 63/472,265, filed on Jun. 9, 2023.

(51) Int. Cl. C23C 4/073; C23C 4/08; C23C 4/10; C23C 4/129

(52) U.S. Cl. CPC C23C 4/073; C23C 4/08; C23C 4/10; C23C 4/129

(57) ABSTRACT

A method for applying a coating includes: providing a mixture of MCrAlY, Cu, Mo, and BaF₂ powders; and spraying the mixture on a metallic substrate. A heat treating in an oxidizing atmosphere may form at least a surface layer of: BaCrO₄; BaMoO₄; CuTa₂O₆; Cu₂O; and CuO. The substrate may form a seal such as a split ring seal.

### CROSS-REFERENCE TO RELATED APPLICATIONS

Benefit is claimed of U.S. Patent Application No. 63/455,532, filed Mar. 29, 2023, and entitled “Multicomponent Coating” and U.S. Patent Application No. 63/472,265, filed Jun. 9, 2023, and entitled “Multicomponent Coating”, the disclosures of which are incorporated by reference herein in their entireties as if set forth at length.

### BACKGROUND

The disclosure relates to gas turbine engines. More particularly, the disclosure relates to coatings for hot section piston seal rings (PSR).

Gas turbine engines (used in propulsion and power applications and broadly inclusive of turbojets, turboprops, turbofans, turboshafts, industrial gas turbines, and the like) use piston seal rings (PSR) in a variety of locations.

Coatings produced by different thermal spray techniques are being used in a wide variety of applications. They can perform different functions such as thermal barriers, abradable, corrosion and wear resistant and, for each application, different strategies and choices of materials can be used to achieve the different properties desired for the target application. When high temperature conditions are involved, the protection against wear and corrosion in elevated temperatures becomes a main engineering challenge, because oxidation and the attack by corrosive elements combined with friction and mechanical wear can damage the materials exposed to those conditions, leading to premature failure of engineered parts.

Currently, superalloy (e.g., IN-718 (UNS N07718/W.Nr. 2.4668, Inconel® alloy 718 Huntington Alloys Corp., Huntington WV)) static seals are commonly used uncoated in turbine engine hot sections and may be subject to damage by hot corrosion. Effects of hot corrosion often are reflected in weight/mass gain. Bare superalloys may have a weight gain up to 25 mg/cm² when exposed to hot corrosion conditions such as 0.5 mg/cm² of Na₂SO₄ at 900° C. for 24 hours. Such high weight gain means that the alloy is being attacked by sulfur, which could lead to premature failure of the seal and mating counterface component. Furthermore, these parts are also exposed to severe tribological conditions, which means they suffer premature wear during high temperature operation. The use of commercially available self-lubricating coatings can increase the lifetime of these parts by improving tribological performance. However, these self-lubricating coatings (such as the NASA-developed PS304 and PS400) have shown poor resistance to hot corrosion conditions. PS304 is disclosed in U.S. Pat. No. 5,866,518 of DellaCorte et al., entitled “Self-Lubricating Composite Chromium Oxide”, issued Feb. 2, 1999. PS304 generally has NiCr binder with Cr₂O₃ hardener and Ag+ fluorides solid lubricant. PS400 is disclosed in U.S. Pat. No. 8,753,417 of DellaCorte et al., entitled “High Temperature Solid Lubricant Coating for High Temperature Wear Applications”, issued Jun. 17, 2014.PS400 generally has NiMoAl binder with Cr₂O₃ hardener and Ag+ fluorides solid lubricant.

A more recent proposal for a coating for such a PSR is found in US Patent Application Publication 2021/0270369A1 of Stoyanov et al., entitled “Wear Resistant Self-Lubricating Static Seal”, published Jan. 6, 2022, the disclosure of which is incorporated by reference herein in its entirety as if set forth at length.

Another seal configuration is the W-seal of which an example is found in US Patent Application Publication 2022/0065122A1 (the '122 publication) of Stoyanov et al., entitled “Seals and Methods of Making Seals”, published Mar. 3, 2022, the disclosure of which is incorporated by reference herein in its entirety as if set forth at length. The '122 publication discloses both PSR and self-sprung compression seals. The self-sprung compression seals have cross-sections characterized by one or more cycles of a C-shape or W-shape. With such seals, sometimes because of seal orientation a different letter may be used (e.g., the letter E may be used to designate a radially compressed seal; whereas, the letter W may be used to designate an axially-compressed seal of similar cross-section but oriented 90° opposite). The '122 publication discloses both baseline seals made of conventional alloys (e.g., nickel-based superalloys) and modified seals made of HEA.

### SUMMARY

One aspect of the disclosure involves a method for applying a coating, the method comprising: providing a mixture of MCrAlY, Cu, Mo, and BaF₂ powders; and spraying the mixture on a metallic substrate.

In further embodiments of any of the foregoing embodiments, additionally and/or alternatively, the mixture further comprises: Cr₂O₃ powder (e.g., up to 65.0% or 10.0% to 65% or 10.0% to 50.0%).

In a further embodiment of any of the foregoing embodiments, additionally and/or alternatively, the spraying is HVOF, HVAF, or cold spray.

In further embodiments of any of the foregoing embodiments, additionally and/or alternatively, may include the spraying is HVOF spraying.

In further embodiments of any of the foregoing embodiments, additionally and/or alternatively, the MCrAlY is a NiCoCrAlY or CoNiCrAlY.

In further embodiments of any of the foregoing embodiments, additionally and/or alternatively, the mixture has a combined content said Mo and the Co of said MCrAlY of 12.5 weight percent to 45.0 weight percent.

In further embodiments of any of the foregoing embodiments, additionally and/or alternatively, the MCrAlY is a NiCoCrAlTaY.

In further embodiments of any of the foregoing embodiments, additionally and/or alternatively, the NiCoCrAlTaY comprises by weight percent: Ni as a largest by weight constituent; 20.0 to 26.0 Co; 18.0 to 23.0 Cr; 6.0 to 11.0 Al; 2.0 to 6.0 Ta; and 0.3 to 0.9 Y.

In further embodiments of any of the foregoing embodiments, additionally and/or alternatively, the NiCoCrAlTaY comprises by weight percent: 20.0 to 26.0 Co; 18.0 to 23.0 Cr; 6.0 to 11.0 Al; 2.0 to 6.0 Ta; 0.3 to 0.9 Y; balance Ni plus impurities.

In further embodiments of any of the foregoing embodiments, additionally and/or alternatively, the NiCoCrAlTaY comprises by weight percent: 16.0 to 26.0 Co; 15.0 to 23.0 Cr; 5.0 to 14.0 Al; up to 9.0 Ta; 0.2 to 0.9 Y; balance Ni plus up to 5.0 other total and 1.0 each other individually.

In further embodiments of any of the foregoing embodiments, additionally and/or alternatively, the mixture comprises by weight: 20% to 80% MCrAlY; 2.5% to 20% Cu; 2.5% to 10% Mo; 2.5% to 10% BaF₂; and up to 60% Cr₂O₃.

In further embodiments of any of the foregoing embodiments, additionally and/or alternatively, the mixture comprises by weight: 0% to 60% Cr₂O₃; and no more than 5.0% total other than the MCrAlY, Cu, Cr₂O₃, Mo, and BaF₂.

In further embodiments of any of the foregoing embodiments, additionally and/or alternatively, may include heat treating in an oxidizing atmosphere so as to form: BaCrO₄; BaMoO₄; CuTa₂O₆; Cu₂O; and CuO.

In further embodiments of any of the foregoing embodiments, additionally and/or alternatively, the substrate is a split ring seal substrate and the spraying is at least to an outer diameter surface of the substrate; or the substrate is a spring compression seal substrate and the spraying is at least to an outer an axial end surface portion of the substrate; or the substrate is a HALO seal substrate and the spraying is to an inner diameter surface of the substrate; or the substrate is a locating pin substrate and the spraying is to a base of the locating pin (substrate) or a distal end section of the locating pin (substrate); or the substrate interfaces with a locating pin and the spraying is to a counterface surface for the locating pin; or the substrate is a snap fastener substrate and the spraying is to a shaft and a barb underside; or the substrate is of a component having a snap fit bead or groove and the spraying is to said bead or groove; or the substrate is of a component having a tab and the spraying is to a face of the tab; or the substrate is of a component having a seal counterface and the spraying is to the seal counterface.

Further embodiments of any of the foregoing embodiments, additionally and/or alternatively, may include a coated substrate wherein the coating is applied according to the methods.

In further embodiments of any of the foregoing embodiments, additionally and/or alternatively, the coating has an HV0.3 hardness of at least 260.

In further embodiments of any of the foregoing embodiments, additionally and/or alternatively, the coating has a thickness of 100 micrometers to 700 micrometers.

In further embodiments of any of the foregoing embodiments, additionally and/or alternatively, the substrate is a Ni-based alloy.

In further embodiments of any of the foregoing embodiments, additionally and/or alternatively, the substrate forms a piston seal ring and the coating is on an outer diameter surface of the substrate.

A further aspect of the disclosure involves a coated substrate comprising: a metallic substrate; and a coating on the metallic substrate. The coating comprises: an MCrAlY-based matrix; a soft metal (e.g., Cu, Ag, Au, Pt); a fluoride species (e.g., BaF₂ and/or CaF₂); molybdenum. This may represent an as-applied coating composition.

In further embodiments of any of the foregoing embodiments, additionally and/or alternatively, the coating has a combined content said molybdenum and, if any, cobalt of said MCrAlY of 12.5 weight percent to 45 weight percent.

In further embodiments of any of the foregoing embodiments, additionally and/or alternatively, the MCrAlY-based matrix may be sprayed from powder having a 5-45 micrometer size distribution.

In further embodiments of any of the foregoing embodiments, additionally and/or alternatively: said MCrAlY comprises 10 to 35 Co by weight; and a processing method comprises heat treating to form a surface sublayer of the coating comprising oxides of: said Co; said molybdenum; barium and/or calcium from said fluoride species; and said soft metal.

In further embodiments of any of the foregoing embodiments, additionally and/or alternatively, the coating comprises by weight percent: 2.5 to 10.0 said fluoride species being BaF₂; 2.5 to 10.0 said molybdenum; 20.0 to 80.0 said MCrAlY; and 2.0 to 20.0 said soft metal being copper.

In further embodiments of any of the foregoing embodiments, additionally and/or alternatively, a heat treatment may transform the as-applied coating so that, in at least a surface layer: the fluoride species and Cr from the MCrAlY oxidizes to form BaCrO₄ and/or CaCrO₄; the soft metal oxidizes; and Ni₃Al precipitates. The heat treatment may transform the as-applied coating so that some of the fluoride species and the Mo oxidizes to form BaMoO₄ and/or CaMoO₄.

In further embodiments of any of the foregoing embodiments, additionally and/or alternatively: the substrate is a split ring seal substrate and the coating is at least on an outer diameter surface of the substrate; or the substrate is a spring compression seal substrate and the coating is at least on an outer an axial end surface portion of the substrate; or the substrate is a HALO seal substrate and the coating is at least on an inner diameter surface of the substrate; or the substrate is a locating pin substrate and the coating is at least on a base of the locating pin (substrate); or the substrate interfaces with a locating pin and the coating is on (or the spraying is to) a counterface surface for the locating pin; or the substrate is a snap fastener substrate and the coating is at least on a shaft and a barb underside; or the substrate is of a component having a snap fit bead or groove and the coating is at least on said bead or groove; or the substrate is of a component having a tab and the coating is at least on a face of the tab; or the substrate is of a component having a seal counterface and the coating is at least on the seal counterface.

A further aspect of the disclosure involves a coated substrate comprising: a metallic substrate; and a coating on the metallic substrate. The coating and has at least a surface layer comprising: an MCrAlY matrix; BaCrO₄ and/or CaCrO₄; BaMoO₄ and/or CaCrO₄; CuTa₂O₆; Cu₂O; CuO; and Ni₃Al precipitates. The surface layer may also comprise Cr₂O₃.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a scanning electron microscopy image of a HVOF first coating (designated HV80) after deposition.

FIG. 2 is a scanning electron microscopy image of powder, after mixing, used to spray the coating of FIG. 1.

FIG. 3 is a scanning electron microscopy image of a HVOF second coating (designated HV60) after deposition.

FIG. 4 is a scanning electron microscopy image of an APS third coating (designated AP60) after deposition.

FIG. 5 is a scanning electron microscopy image of powder, after mixing, used to spray the coatings of FIGS. 3 and 4.

FIG. 6 is a photograph of NiCoCrAlTaY particles.

FIG. 7 is a photograph of Mo particles.

FIG. 8 is a photograph of Cu particles.

FIG. 9 is a photograph of BaF₂ particles.

FIG. 10 is a photograph of Cr₂O₃ particles.

FIG. 11 is a plot of NiCoCrAlTaY particle size distribution.

FIG. 12 is a plot of Mo particle size distribution.

FIG. 13 is a plot of Cu particle size distribution.

FIG. 14 is a plot of BaF₂ particle size distribution.

FIG. 15 is a plot of Cr₂O₃ particle size distribution.

FIGS. 16 and 17 are two scanning electron microscopy (SEM) images of two locations on the second coating (HV60) after heat treatment.

FIG. 18 is a scanning electron microscopy (SEM) image of the first coating (HV80) after heat treatment. FIG. 18A is an enlarged view of an upper region of the coating of FIG. 18.

FIG. 19 is a scanning electron microscopy image of the first coating after heat treatment. FIG. 19A is an enlarged view of an upper region of the coating of FIG. 19.

FIG. 20 is a scanning electron microscopy image of the third coating after heat treatment.

FIG. 21 is a pair of X-ray diffraction patterns for the first coating (HV80) before (lower trace) and after (upper trace) heat treatment.

FIG. 22 is a pair of X-ray diffraction patterns for the second coating (HV60) before (lower trace) and after (upper trace) heat treatment.

FIG. 23 is a pair of friction coefficient plots for HV60 at room temp (25° C.) (upper trace) and elevated temperature (300° C.) (lower trace).

FIG. 24 is a pair of friction coefficient plots for HV60 at room temp (25° C.) (upper trace) and elevated temperature (300° C.) (lower trace) both after heat treatment.

FIG. 25 is a wear track plot for HV 60 at room temperature as-deposited (pre-heat treat).

FIG. 26 is a wear track plot for HV 60 at elevated temperature (300° C.) as-deposited (pre-heat treat).

FIG. 27 is a wear track plot for HV 60 at room temperature post-heat treat.

FIG. 28 is a wear track plot for HV 60 at elevated temperature (300° C.) post-heat treat.

FIG. 29 is a view of a gas turbine engine.

FIG. 29A is an enlarged view of a first seal system in the engine of FIG. 29.

FIG. 29B is an enlarged view of a second seal system in the engine of FIG. 29.

FIG. 29C is an enlarged view of a third seal system in the engine of FIG. 1.

FIG. 29D is an enlarged view combustor swirler in the engine of FIG. 1.

FIG. 30 is a longitudinal sectional/cutaway view of a locating pin joint.

FIG. 31 is a longitudinal sectional view of a snap fastener joint.

FIG. 32 is an inward radial view of a mounting tab-in-slot joint.

FIG. 33 is a longitudinal sectional view of the joint of FIG. 32.

FIG. 34 is a longitudinal sectional view of an alternate locating pin joint.

Like reference numbers and designations in the various drawings indicate like elements.

### DETAILED DESCRIPTION

As noted above, bare nickel-based superalloys show high friction coefficients and high wear rates when exposed to elevated temperature conditions. Furthermore, these materials are susceptible to hot corrosion conditions, which causes the degradation of the parts that are exposed to molten salts inside the engine. Embodiments of the present proposed coating for which test data is discussed below showed not only better tribological behavior when compared to uncoated IN-718, but also better hot corrosion behavior when compared to such substrate material with state-of-the-art self-lubricating coatings (PS304 and PS400).

Elevated wear may cause premature failure of engine parts, leading to longer repair time and shorter times between overhaul, increasing overall maintenance costs.

By adding a MCrAlY-based material as a matrix in a self-lubricating coating, and by adding other components such as copper, barium fluoride (and/or calcium fluoride) and molybdenum, at least some embodiments of the present self-lubricating coatings not only have good hot corrosion resistance but are also capable of forming beneficial oxides at the contact interface, providing low wear and low friction for applications such as seals (e.g., piston seal rings (PSR)). A particular tested MCrAlY discussed below is a NiCoCrAlTaY.

Thus, to improve the wear and corrosion relative to bare superalloy and the NASA PS coatings, embodiments of the present coating composition are designed to produce ternary oxides under high temperature conditions. Such ternary oxides may be produced by two different mechanisms: (1) formed when exposed to high temperatures (either during operation or heat treatment); or (2) formed during the relative movement between the coated surface and the counterface in high temperature conditions (mechanically mixed/tribo-oxidation) which will then further extend the lifetime of the coating and substrate when exposed to tribological conditions. This new composition is expected to offer higher temperature stability than the state-of-the-art self-lubricating coatings (e.g., the PS-series), which will allow for an increase in its maximum operation temperature. Specifically, PS304 uses a Ni20Cr with a published service temperature of 980° C.; PS 400 uses Ni5Mo5.5Al with a published service temperature of 650° C. The MCrAlY offers higher service temperatures (e.g., 1050° C. for Amdry™ 997 powder). Furthermore, it is expected that the new composition will protect the substrate against wear damage by forming lubricious oxides which will reduce friction and wear at elevated temperature.

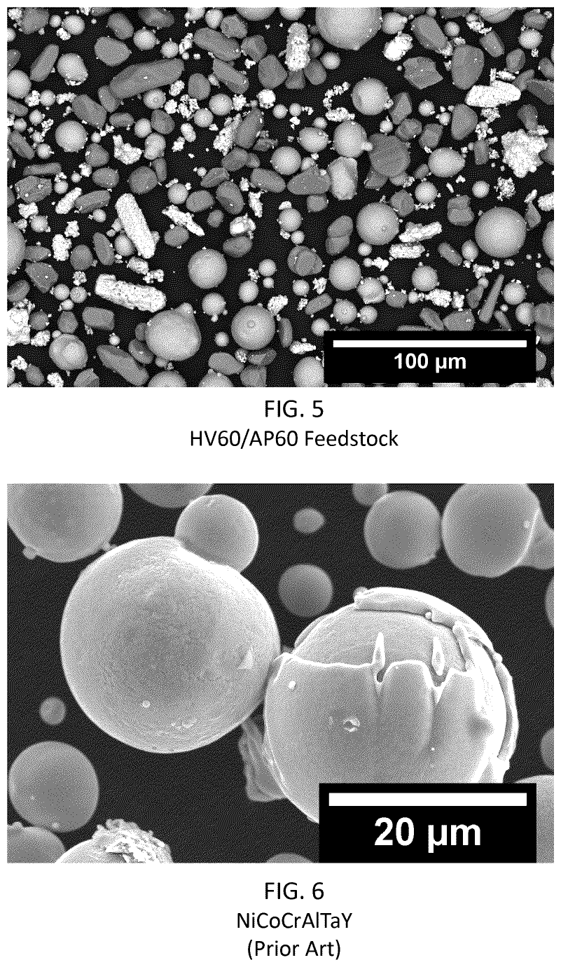

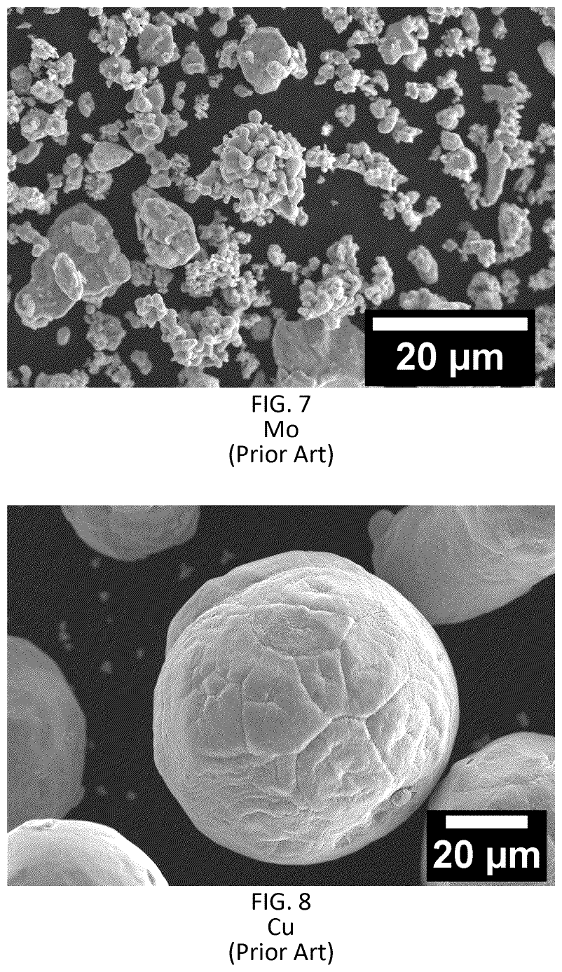

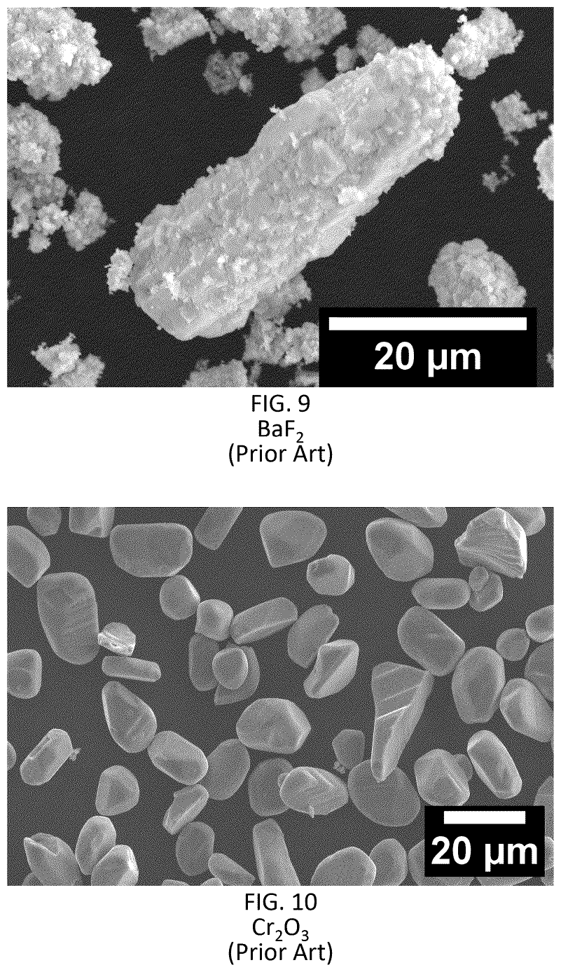

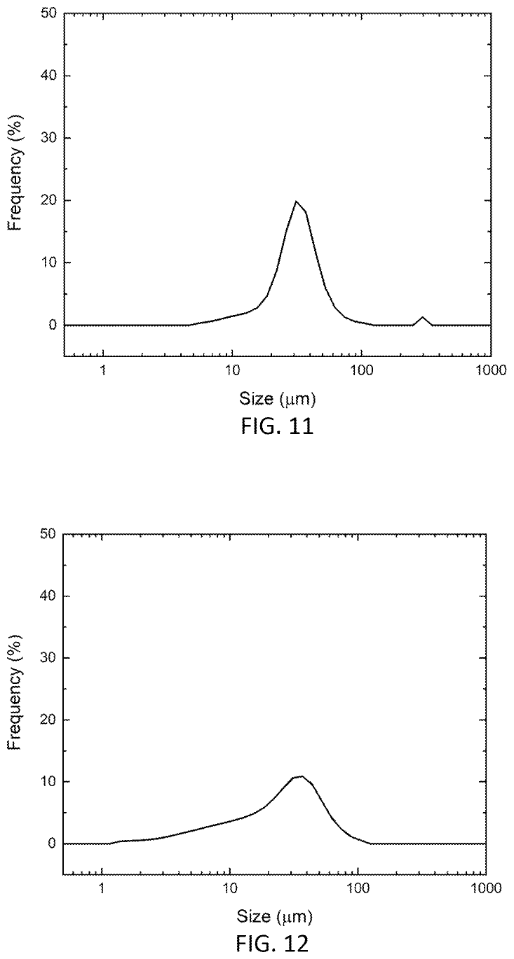

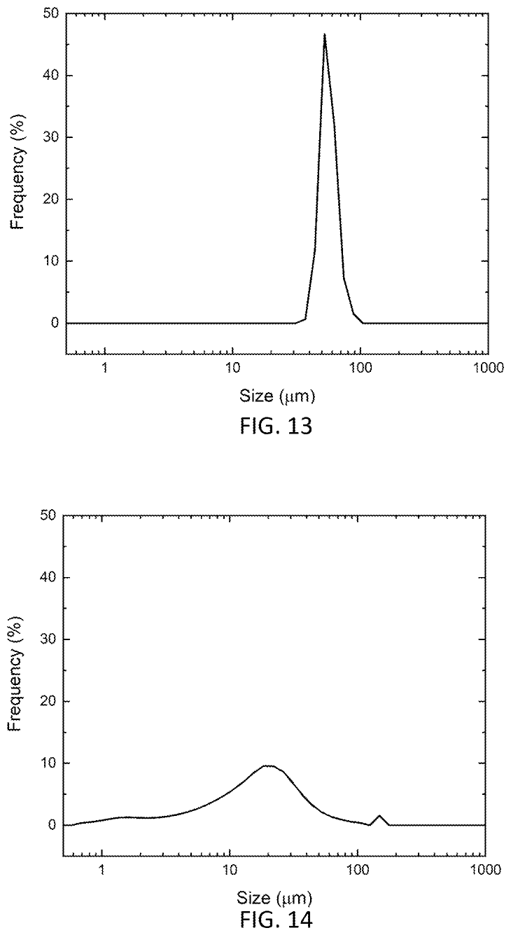

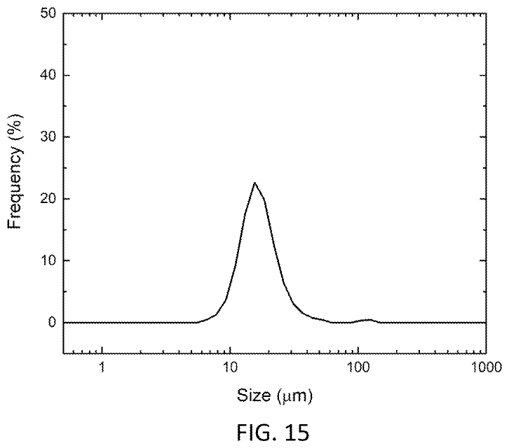

In one group of examples, a mixed powder feedstock for the coating comprises: a NiCoCrAlTaY (FIG. 6); Mo (FIG. 7); Cu (FIG. 8); BaF₂ (barium fluoride) (FIG. 9) and/or CaF₂ (calcium fluoride); and/or Cr₂O₃ (chromium oxide) (FIG. 10). The mixed powder feedstock is shown in FIG. 2 (without chromium oxide, HV80) and FIG. 5 (with chromium oxide, HV60/AP60). A small particle size was chosen to facilitate the melting of chromium oxide (melting point 2435° C.), which could help while spraying the composition by high velocity oxy-fuel (HVOF). Example NiCoCrAlTaY is by weight percent: 20.0 to 26.0 Co; 18.0 to 23.0 Cr; 6.0 to 11.0 Al; 2.0 to 6.0 Ta; 0.3 to 0.9 Y; balance Ni plus impurities. A particular example is available from Oerlikon Metco (Oerlikon Surface Solutions AG, Pfaeffikon Switzerland) as Amdry™ 997 powder.

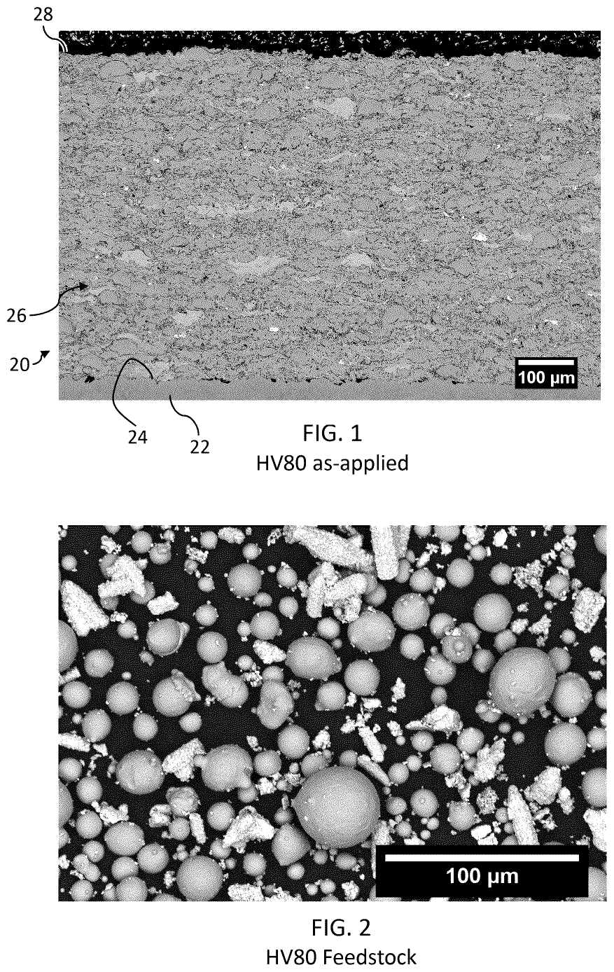

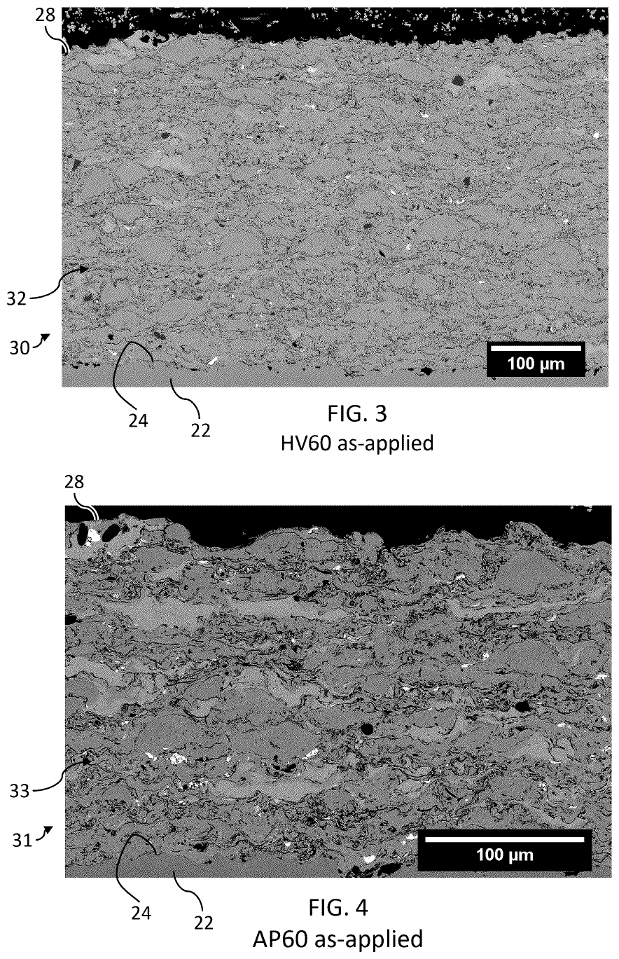

Coatings containing the compositions shown in Table 1 were successfully produced by HVOF and atmospheric plasma spray (APS) (parameters shown in Table 4), with cross-section images being shown in FIG. 1 (HV80), FIG. 3 (HV60), and FIG. 4 (AP60). In these figures, the coated article is shown as 20, 30, 31; the substrate as 22, the substrate surface as 24; the coating as 26, 32, 33; the coating surface as 28.

These two tested compositions were designed to be deposited by high velocity oxy-fuel (HVOF) to minimize porosity in the coating. However, during the deposition of the HV60 coating, it was observed that the chromium oxide particles did not melt, but instead, the particles were entrapped by subsequent particles being impinged at the surface. This could lead to the release of these hard particles during tribological testing. The melting points of Cr₂O₃ and Mo (2435° C. and 2623° C. respectively) are considerably higher than the other components of the mix. Achieving such high temperature in HVOF is challenging (the gas temperature is usually in the range of 2500° C. to 3500° C., meaning that particle temperature is considerably lower than that). Thus, atmospheric plasma spray (APS) was proposed as a second option, since it has higher gas temperature (up to 10,000° C.), making it a candidate technique to spraying these components. Thus, the AP60 was proposed, using exact same composition as the HV60, but changing the deposition method to APS. As is discussed further below, one of the main disadvantages of APS is the production of more porous coatings due to the lower velocity of the gases and particles when compared to HVOF. Additionally, high velocity air-fuel (HVAF) and cold spray are candidates. Of these three non-plasma techniques, HVOF generally has higher operating temperature and lower particle velocity than HVAF and cold spray. Cold spray generally has the lowest operating temperature and highest particle velocity. HVAF is generally intermediate in both parameters.

All the initial powder components are present in the coating, and a deposition efficiency of 63% was observed for the HVOF coating produced without chromium oxide (HV80). When chromium oxide particles were added (partially substituting for HV80 NiCoCrAlTaY to form HV60/AP60), the deposition efficiency reduced to 37% (HV60). The spray process was then changed from HVOF to APS, and an increase in the deposition efficiency from 37% to 47% was observed for the deposition of the AP60 coating due to the higher thermal input provided by the plasma gun. Although the FIG. 4 AP60 coating shows lower thickness than the FIG. 3 HV60, a lower powder feed rate was used for the APS process (18 g/min for the AP60 against 38 g/min for the HV60) and a different number of passes (thirty-five passes for APS and forty passes for HVOF).

TABLE 1
Composition, Deposition Process, and Hardness

| Coating | Composition | Deposition | Hardness |
|---|---|---|---|
| name | (wt. %) | process | (HV0.3) |
| HV80 | 80% | HVOF | 340 ± 30 |
| | NiCoCrAlTaY, | | |
| | 10% Cu, 5% Mo, | | |
| | 5% BaF₂ | | |
| HV60 | 60% | HVOF | 370 ± 38 |
| | NiCoCrAlTaY, | | |
| | 20% Cr₂O₃, 10% | | |
| AP60 | Cu, 5% Mo, 5% | APS | 260 ± 23 |
| | BaF₂ | | |

TABLE 2
Wear Rates Friction and Coefficient
(Measured against Alumina Counterface)

| | Wear rate | | | |
|---|---|---|---|---|
| | (×10⁻⁵) | | | |
| | mm³/N · m | | Friction Coefficient | |
| Material | RT | 300° C. | RT | 300° C. |
| IN-718 | 71 | 147 | 0.70 ± 0.05* | 0.73 ± 0.08* |
| PS304 | 4.0 | 1.9 | 0.71 ± 0.06 | 0.39 ± 0.02 |
| PS400 | 2.6 | 20.2 | 0.52 ± 0.02 | 0.29 ± 0.01 |
| HV80 | 48 | 73 | 0.62 ± 0.04 | 0.47 ± 0.04 |
| HV80— | 1.08 | 0.87 | 0.51 ± 0.01 | 0.38 ± 0.01 |
| Heat treated | | | | |

*Measured in a prior test by colleagues.

The HV80 substrate was 704L stainless steel. The PS304/400 substrate was X-750 (UNS N07750/W. Nr. 2.4669, Inconel® alloy X750, Huntington Alloys Corp., Huntington, West Virginia) precipitation-hardenable nickel-chromium alloy. The IN-718, PS304, and PS400 were not heat treated. The HV80 heat treatment was 1040° C. for 4 hours in a muffle furnace in uncontrolled atmosphere. Surface oxide produced by the heat treatment was left in place for the tribological test.

TABLE 3
Weight Change/Area (mg/cm²)

| | Oxidation | | | Hot Corrosion | | |
|---|---|---|---|---|---|---|
| Coating | 550° C. | 850° C. | 950° C. | 550° C. | 850° C. | 950° C. |
| PS304 | 3.6 | 16.1 | 26.3 | 2.2 ± 0.1 | 23 ± 5 | 21 ± 1 |
| PS400 | 4.7 | 5.9 | 20.8 | 3.5 ± 0.9 | 13 ± 4 | 24 ± 4 |
| HV80 | 1.3 ± 0.2 | 4.0 ± 0.4 | 5.8 ± 0.2 | −0.95 ± 0.06 | 1.6 ± 0.3 | 5 ± 2 |
| (As-deposited) | | | | | | |

Only the tribological tests were done in a heat treated condition. However, oxidation and hot corrosion performance of HV80 is believed to be relatively unaffected (i.e., still much better than PS304 and PS400) by a potential surface oxide generated by the heat treatment.

TABLE 4
Deposition Parameters

| Parameter | HVOF | APS |
|---|---|---|
| Feed rate (g/min) | 38 | 18.6 |
| Oxygen flow rate (nlpm) | 152 | NA |
| Propylene (Fuel) (nlpm) | 85 | NA |
| Argon flow rate (slpm) | NA | 35 |
| Helium flow rate (slpm) | NA | 35 |
| Air (nlpm) | 284 | NA |
| Transverse speed (mm/s) | 1000 | 1000 |
| Spraying distance (mm) | 250 | 90 |
| Number of passes | 35 | 40 |

(nlpm is measured at 101.325 kPa and 0° C.; slpm is measured at 100 kPa and 0° C.)

Table 5 below provides, in Ex. 1 and Ex. 2, the example proportions of MCrAlY, Mo, BaF₂, and Cr₂O₃, for the HV80 and HV60/AP60 examples above.

TABLE 5
Powder Mix

| | Weight Percent | | | | | |
|---|---|---|---|---|---|---|
| | MCrAlY | Cu | Mo | BaF₂ | Cr₂O₃ | Other |
| Ex. 1 | 80 | 10 | 5 | 5 | 0 | 0 |
| Ex. 2 | 60 | 10 | 5 | 5 | 20 | 0 |
| Ex. 3 | 20 | 10 | 5 | 5 | 60 | 0 |
| Ex. 4 | 70 | 10 | 5 | 5 | 10 | |
| Range 1 | ≥50.0 | 5.0-12.0 | 3.0-10.0 | 3.0-10.0 | ≤25.0 | ≤10.0 tot |
| Range 2 | 55.0-85.0 | 5.0-12.0 | 3.0-10.0 | 3.0-10.0 | ≤25.0 | ≤10.0 tot |
| Range 3 | 55.0-85.0 | 5.0-12.0 | 3.0-7.0 | 3.0-7.0 | ≤25.0 | ≤2.0 tot. |
| Range 4 | ≥50.0 | 8.0-12.0 | 3.0-7.0 | 3.0-7.0 | ≤25.0 | ≤2.0 tot. |
| Range 5 | 20.0-80.0 | 8.0-12.0 | 3.0-7.0 | 3.0-7.0 | ≤65.0 | ≤2.0 tot |
| Range 6 | 15.0-85.0 | 5.0-12.0 | 3.0-10.0 | 3.0-10.0 | ≤50.0 | ≤10.0 tot |
| Range7 | 20.0-80.0 | 2.5-20.0 | 2.5-10.0 | 2.5-10.0 | ≤65.0 | ≤2.0 tot |
| Range 8 | 20.0-80.0 | 2.5-20.0 | 2.5-10.0 | 2.5-10.0 | ≤6.0 | ≤2.0 tot |

Optionally, some of the BaF₂ may be substituted with CaF₂. For example, 0 to all substituted on a 1:1 molar basis or a 1:1 weight basis, more narrowly, up to 75% or 50% or 25%.

Optionally, some or all of the copper may be substituted with Ag, Au and/or Pt. For example, 0 to all substituted on a 1:1 molar basis or a 1:1 weight basis, more narrowly, up to 75% or 50% or 25%.

For any of the ranges, further ranges may be created by modifying the “Other” entry such as to include one or more of ≤2.0 (or 5.0 or 10.0) tot. optionally in combination with ≤0.5 (or 1.0 or 2.0 or 3.0 or 4.0 or 5.0) each other element individually.

For any of the ranges, further ranges may be created by modifying the “Cr₂O₃” entry to add a lower end of 5.0 or 10.0 or 20.0 or, for Ranges 5-7, 40.0.

Ex. 3 was thought to be beneficial from review of the Ex. 1 and 2 results, but its tests were not completed due to a hardware failure unrelated to the Ex. 3 parameters. Ex. 3 is thought to be potentially beneficial vs. Ex. 1 and 2 based on experience with PS-series coatings. Specifically, U.S. Pat. No. 5,866,518 (cited above) showed PS300 containing more oxides had increased hardness vs. lower-oxide PS304 and provided better wear resistance (ref. Table 3 results from U.S. Pat. No. 5,866,518).

Table 6 below provides, candidate MCrAlY compositions for use with any of the Table 5 proportions of MCrAlY to Mo, BaF₂, and Cr₂O₃. Example MCrAlY are available from Oerlikon Surface Solutions AG (Pfaeffikon Switzerland) under the trademarks Amdry™ and Diamalloy™ and Höganäs AR (Höganäs, Sweden) under the trademark Amperit™. Some of these follow with nominal weight percentage in parentheticals. Example CoCrAlY include Amdry™ 920 (Co 29Cr 6Al 2Si 0.3Y). Example CoNiCrAlY include Diamalloy™ 4700 (Co 32Ni 21Cr 8Al 0.5Y) and Amperit™ 415.001 (Co 32Ni 21Cr 8Al 0.5Y). Example NiCoCrAlY include Amdry™ 365-1 (Ni 23Co 17Cr 12Al 0.5Y), Amdry™ 386 (Ni 22Co 17Cr 12Al 0.5Hf 0.5Y 0.4Si), Amdry™ 997 (Ni 23Co 20Cr 8.5Al 4Ta 0.6Y), Amperit™ 410.001 (Ni 23Co 17Cr 12.5Al 0.5Y), and Amperit™ 421.001 (Ni 18Cr 10Co 6.5Al 6.0Ta 2.0 Re 0.3 Y 1Si 0.5 Hf). Example NiCrAlY include Amdry™ 964 (Ni 31Cr 11Al 0.6Y), Amdry 963™ (Ni 24.5Cr 6Al 0.4Y), Amdry™ 9624, and Amperit™ 413.001 (Ni 22Cr 10Al 1Y).

TABLE 6
Candidate MCrAlY

| | Weight Percent | | | | | | |
|---|---|---|---|---|---|---|---|
| | Ni | Co | Cr | Al | Y | Ta | other |
| Ex. 1 Amdry ™ 997 | Bal | 20.0-26.0 | 18.0-23.0 | 6.0-11.0 | 0.3-0.9 | 2.0-6.0 | na |
| Ex. 2 Amperit ™ | Bal | 10 | 18 | 6.5 | 0.3 | 6 | ≤4.0 tot |
| 421.001 and 421.087 | | | | | | | |
| Ex. 3 Amdry ™ 9624 | Bal | — | 21.0-23.0 | 9.0-11.0 | 0.8-1.2 | na | ≤1.0 tot |
| Ex. 4 Amdry ™ 365-1 | Bal | 20.0-26.0 | 14.0-20.0 | 11.0-14.0 | 0.1-0.8 | na | ≤1.0 tot |
| Ex. 5 Amdry ™ 920 | — | Bal | 27.0-31.0 | 5.0-7.0 | 0.05-0.5 | na | ≤4.0 tot |
| Ex.6 Amdry ™ 9951, | 29.0-35.0 | Bal | 18.0-24.0 | 5.0-11.0 | 0.1-0.8 | na | ≤1.0 tot |
| Diamalloy ™ 4454, | | | | | | | |
| Diamalloy ™ 4700 | | | | | | | |
| Range 1 | Bal | 16.0-23.0 | 15.0-23.0 | 5.0-10.0 | 0.2-0.9 | 3.0-9.0 | ≤4.0 tot |
| Range 2 | Bal | ≤35 | 10.0-31.0 | 3.0-15.0 | 0.05-1.2 | ≤10.0 | ≤4.0 tot |
| Range 3 | Bal | ≤30 | 10.0-25.0 | 3.0-15.0 | 0.2-1.0 | ≤10.0 | ≤4.0 tot |
| Range 4 | ≤40.0 | Bal | 20.0-30.0 | 3.0-10.0 | 0.2-1.0 | na | ≤4.0 tot |
| Range 5 | Bal | ≤30 | 10.0-25.0 | 3.0-15.0 | 0.2-1.0 | ≤10.0 | ≤4.0 tot |
| Range 6 | Bal | ≤30 | 10.0-25.0 | 3.0-15.0 | 0.2-1.0 | 2.0-9.0 | ≤4.0 tot |
| Range 7 | Bal | 10.0-23.0 | 17.0-20.0 | 8.0-12.0 | 0.4-0.7 | na | ≤1.0 tot |
| Range 8 | Bal | 16.0-26.0 | 15.0-23.0 | 5.0-11.0 | 0.2-0.9 | 3.0-9.0 | ≤4.0 tot |
| Range 9 | Bal | 16.0-26.0 | 15.0-23.0 | 5.0-14.0 | 0.2-0.9 | ≤9.0 | ≤4.0 tot |
| Range 10 | Bal | 16.0-26.0 | 15.0-23.0 | 5.0-14.0 | 0.3-0.9 | ≤9.0 | ≤4.0 tot |

Further ranges may be created by taking the min and max for each element of all the existing “examples” or may be created around the max and mins of the nominal values listed inline in the preceding paragraph. Or subgroups may just be the nominals for versions with each combination of Ni, Co, and/or Cr.

The “na” Ta ranges may optionally include Ta within the “Other” limits.

For any of the ranges, Further ranges may be created by modifying the “Other” entry such as to include one or more of ≤2.0 (or 5.0 or 10.0) tot. optionally in combination with ≤0.5 (or 1.0 or 2.0 or 3.0 or 4.0 or 5.0) each other element individually.

Hardness measurements were taken on the top surface of the coating using a Vickers indenter with a load of 300 gf. Such load was used to assess the overall hardness of the coating (probing multiple particles at the same time) while not being high enough to have substrate effects on the results. Fifteen measurements were taken on top of each polished coating and the average with the standard deviation are shown Table 1. Hardness values are similar between the coatings produced by HVOF, but a lower hardness is observed for the coatings produced by APS. Such difference can be attributed to more porosity on the APS coating, a feature that is inherent to coatings produced by the plasma spray process.

The NiCoCrTaAlY powder, chosen as matrix for the coatings, is a subset of MCrAlY coatings, which is a family of materials that are usually employed as corrosion-resistant coatings for high temperature applications. MCrAlY coatings are known for forming a thermally grown Al₂O₃ layer at the top surface when heat treated while also being subjected to interdiffusion. W. Brandl, H. J. Grabke, D. Toma and J. Krüger, “The oxidation behaviour of sprayed MCrAlY coatings”, Surface and Coatings Technology, Dec. 1, 1996, Vol. 86-87, pp. 41-47, Elsevier B.V., Amsterdam, Netherlands.

Because temperatures higher than 1000° C. are high enough to modify the structure of the matrix and diffuse aluminum to form an oxide layer, the NiCoCrTaAlY tests herein aimed to verify if wear resistant ternary oxides could be formed in a coating which had many other elements (the Cu, Mo, Ba, Cr) as candidates for oxide formation. However, for these coatings, the presence of copper limits the maximum temperature of heat treatment, because copper melts at 1085° C. Thus, a heat treatment at 1040° C. for 4 hours in a muffle furnace in uncontrolled atmosphere was chosen to analyze the surface modifications caused by the oxidation and diffusion of the coating components, simulating temperature conditions inside the engine, as well as the effects of the exposure of these coatings to high temperature on their friction and wear behavior.

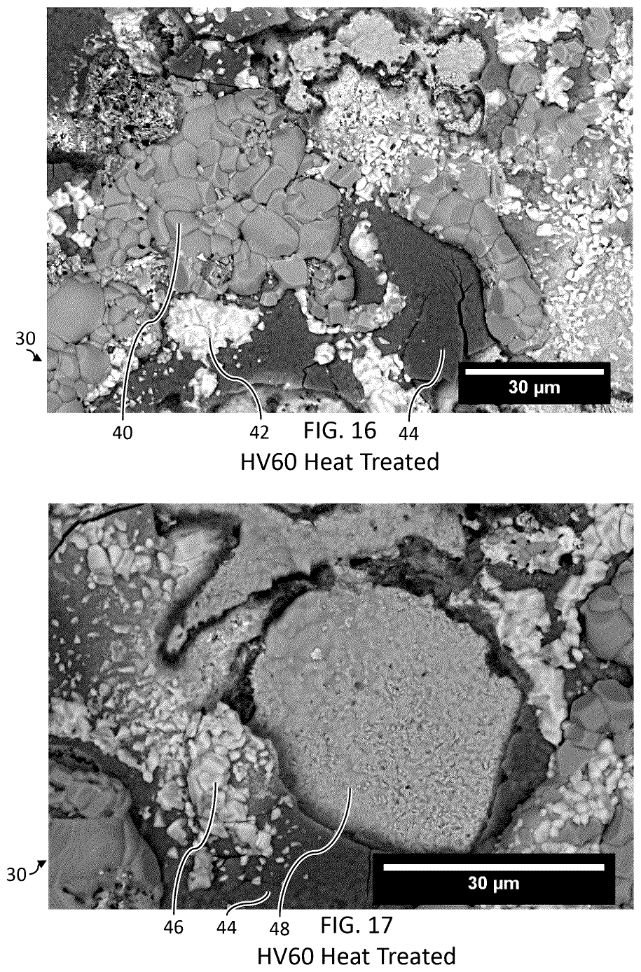

Upon heat treatment, an oxide layer was observed at the surface of the HV60 coating, as shown in FIGS. 16 and 17. Such layer is formed due to the interdiffusion of the different elements present in the coating in a high temperature and oxidizing atmosphere. Chemical analysis of these oxides by energy-dispersive spectroscopy (EDS) has shown the presence of different regions, as shown in FIGS. 16 and 17: oxide regions 40, rich in Ni, Cu, Co, 0; oxide regions 42 rich in Ba, Cu, Cr, 0; oxide regions 44 rich in Al, Cu, 0; oxide regions 46 rich in Ba, Cu, Mo, 0; and relatively nonoxidized region 48 rich in Ni, Cu, Co. The FIG. 17 labeled region 48 appears to have resulted from spalling of oxidized material from the dark region 44 largely encircling it. Some of these regions were analyzed by micro-Raman spectroscopy and BaCrO₄ (barium chromate) were a few of the oxides being formed. Further characterization may focus on using micro-Raman spectroscopy to analyze other regions of the surface of the coating.

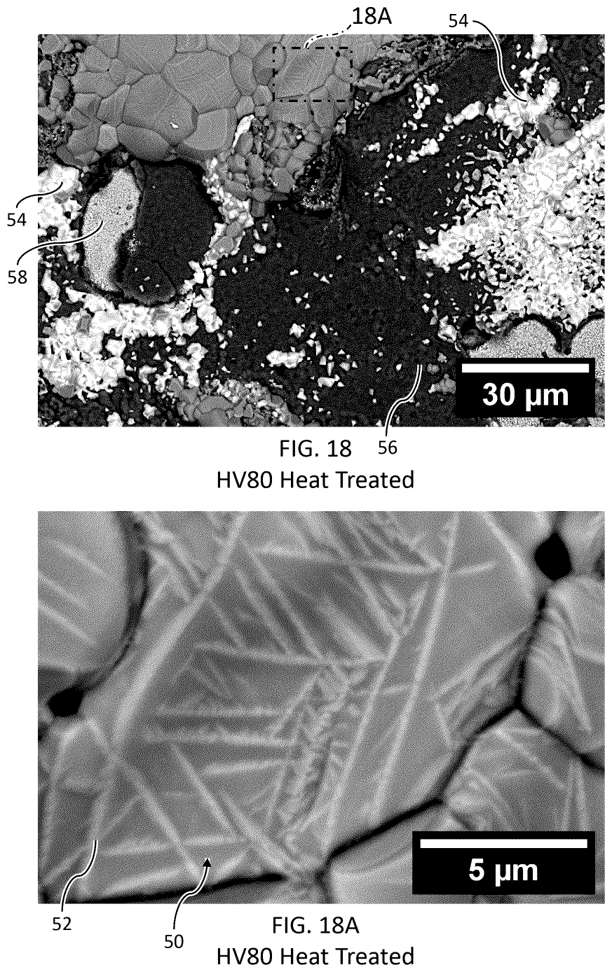

Similarly, for the HV80, chemical analysis by energy-dispersive spectroscopy (EDS) has shown the presence of different regions, as shown in FIGS. 18 and 18A: oxide regions 50 rich in Ni, Cu, Co, O with Cu-rich dendrites 52 (FIG. 18A); oxide regions 54, rich in Ba, Mo, Cr, O; oxide regions 56 rich in Al, Cu and O; and relatively unoxidized regions 58 rich in Al, Cu, among others. Some of these regions were analyzed by micro-Raman spectroscopy and BaCrO₄ (barium chromate) and BaMoO₄ (barium molybdate) were a few of the oxides being formed. Further characterization will focus on using micro-Raman spectroscopy to analyze other regions of the surface of the coating. Region 58 appears to have resulted from spalling of oxidized material such as from the dark region immediately to its right in the image.

Thus, the majority of the surface area in FIGS. 16-18 appears to be formed by oxide phases.

Upon heat treatment of HV80 and AP60 at 1040° C. for 4 hours in a muffle furnace, it was observed that the whole AP60 coating was affected by oxidation, there was only a distinct thin oxide layer for the HV80.

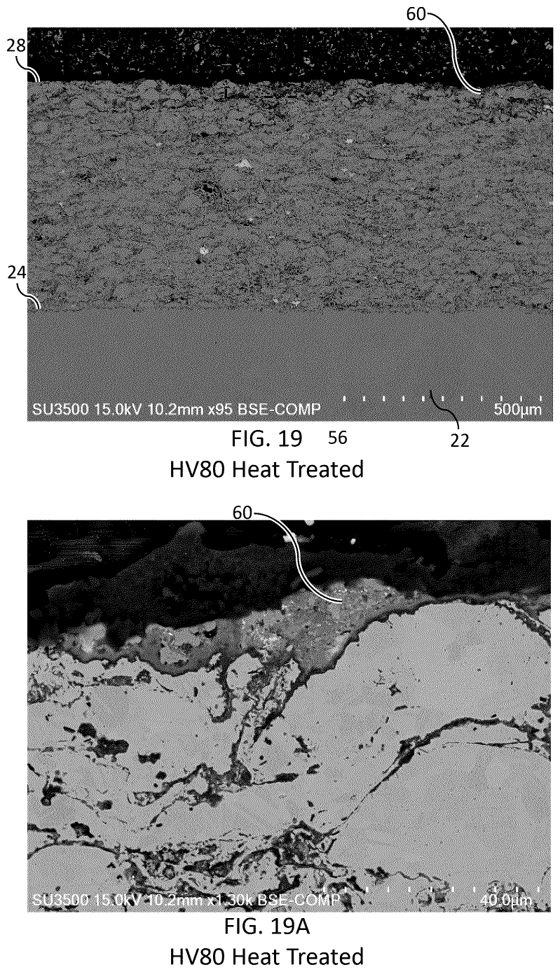

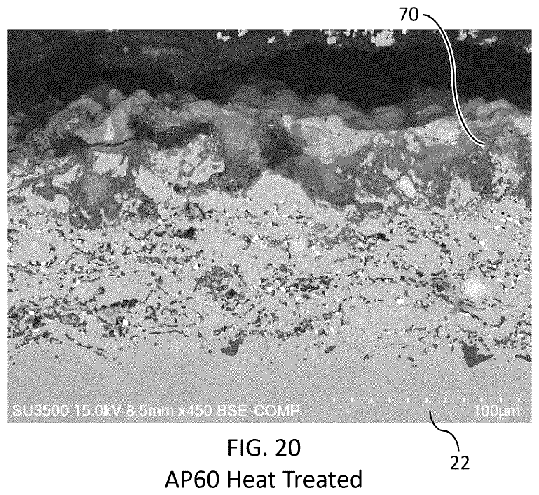

FIG. 19 shows the HV80 (after heat treatment) oxide layer 60 in section 1 micrometer to 15 micrometers in thickness. In the AP60 coating (after heat treatment) of FIG. 20, a much thicker oxide layer 70 (e.g., 40 micrometers to 60 micrometers) is observed. Additionally, there is further noticeable scattered oxide all the way down to the innermost splats near the substrate. This is an artifact of the relatively low velocities of gas and particles in APS relative to HVOF producing greater coating porosity which allows both the thicker apparent oxide layer and the larger amount of oxygen diffusion and resulting oxidation below that layer. In both cases (HV80 and AP60), however, the substrate was protected by the coating against oxidation.

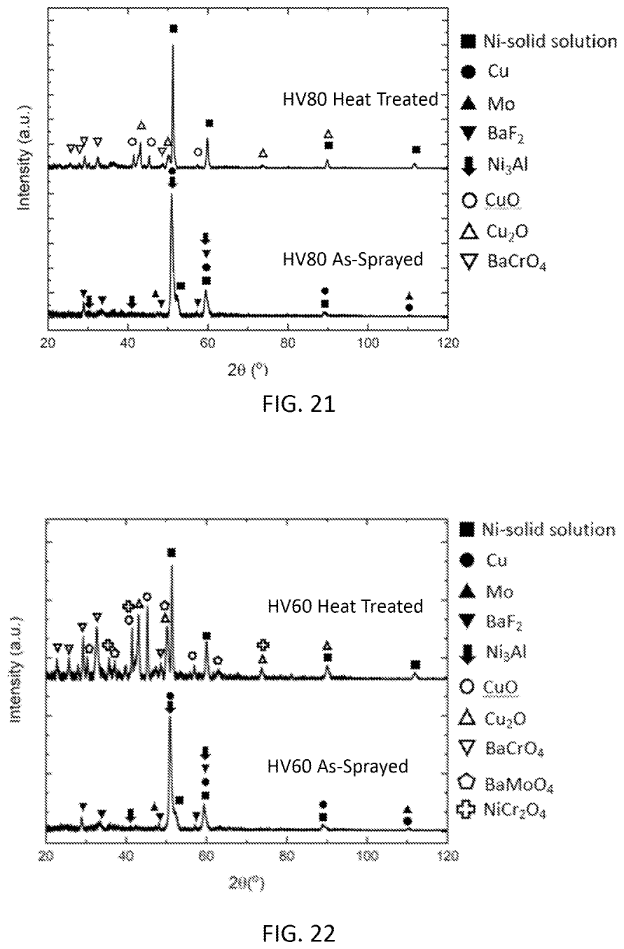

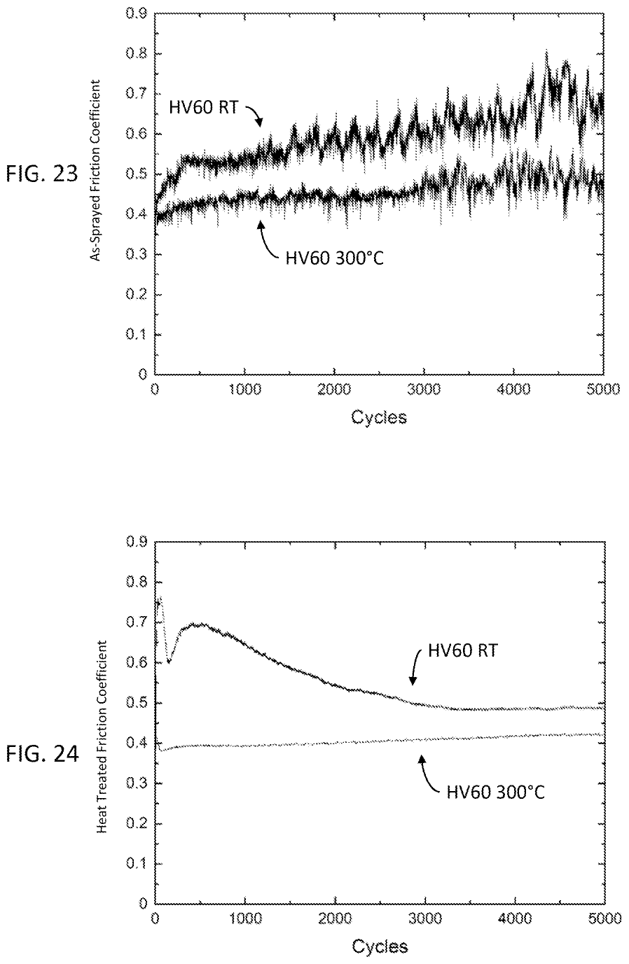

X-ray diffraction was used to compare the HV80 phases before and after heat treatment and the diffractograms are shown in FIG. 21. Before the heat treatment (lower trace), nickel is in a solid solution (Ni-ss) in the main matrix, consisting of Cr, Co, Ta, Al and Y. The shoulder on the right side of the main peak is commonly observed in NiCoCrAlTaY coatings, and it is often attributed to the presence of Ni₃Al and NiAl in the form of precipitates inside the Ni matrix. E. Hao, X. Zhao, Y. An, W. Deng, H. Zhou and J. Chen, “The effect of pre-oxidation on microstructure, mechanical properties and high-temperature tribological behaviors of HVOF-sprayed NiCoCrAlYTa coating”, Applied Surface Science Sep. 30, 2019, Vol. 489, pp. 187-197, Elsevier B.V., Amsterdam, Netherlands. The presence of the other components was also confirmed by the diffractogram.

Once heat treated (FIG. 21 upper trace), the materials get oxidized, and CuO, Cu₂O and NiO are formed. The chromium component of the main matrix reacts with barium forming a ternary phase (BaCrO₄). Meanwhile, the peaks related to nickel in solid solution are still present in the diffractogram, indicating that the oxidation did not occur across the whole coating, and there is metallic nickel below the oxide layer. Some of the components observed in the images were not observed in the diffractogram, and a possible cause is the low concentration of those components, which would be below the detection limit provided by the technique (usually around 5 wt. %). For example, the absence of Mo may reflect oxidation of a portion of the Mo so that both oxidized and unoxidized Mo fall below the detection limit/threshold. The solid solution may have changed relative to pre-heat treat in composition due to both in and out diffusion. In-diffusion may include the soft metal (e.g., Cu), particularly below the oxidized surface sublayer. Out-diffusion may include Al and/or Cr forming oxides. The aluminum may form Al₂O₃ and the chromium may form the oxide with barium and/or calcium (e.g., BaCrO₄).

FIG. 22 similarly provides traces for HV60. Similar components are observed as with HV80, except HV60 also had detection of BaMoO₄ and NiCr₂O₄. For example, the MCrAlY contains tantalum. Therefore, tantalum compounds are expected but may be below the detection threshold. This would particularly be expected to include oxides of tantalum compounds such as CuTa₂O₆ (copper tantalate). Because the HV80 has all the components for these compounds, some of the compounds may be expected to be present. For example, the amount of tantalum in the original powder was relatively small at about 4%, which is then diluted by mixing with other compounds not containing Ta. Thus, Ta might be below detection limit of the XRD equipment.

The coatings are candidates for protecting nickel-based alloys against wear damage in a wide range of temperatures. Although there is limited data in literature, some studies have shown that many uncoated nickel-based alloy substrate (X-750 (INCONEL® alloy X-750 (UNS N07750/W. Nr. 2.4669) Special Metals Corporation, Huntington, West Virginia) can have wear rates in the order of 10⁻³ to 10⁻⁴ mm³/N·m depending on testing conditions and temperature. For these materials, friction can usually range from 0.7 to 1, depending on the material being used as counterface and the testing conditions. J. A. Laskowski and C. DellaCorte, “Friction and wear characteristics of candidate foil bearing materials from 25° C. to 800° C.”, DOE/NASA/50306-11, NASA Report No. TM-107082, 1996, US Department of Energy, Washington, DC. Available at: http://ntrs.nasa.gov/archive/nasa/casi.ntrs.nasa.gov/19960048686.pdf. Thus, ideally, the proposed coatings must have better performance than this baseline value. Table 2 shows the average of the friction coefficient of the HV80 sample tested at room temperature (RT) (25° C.) and at 300° C. in the as deposited and heat-treated conditions against an alumina counterface.

The elevated temperature tests were performed at a set temperature of 450° C. However, because the equipment is open to the atmosphere and not inside an enclosed space, heat is lost to the air in the testing lab. The maximum temperature measured on the surface of the PS304 and PS400 coatings was 350° C. (deposited on X-750 substrate) used for comparison on Table 2. Meanwhile, the tests on HV60 and HV80 (heat treated and non-heat treated) reached a maximum measured surface temperature of 300° C., (deposited on a steel substrate). The difference may be attributed to the difference of thermal conductivity of the steel vs. X-750 as well as coating and substrate thickness. Despite testing the present parameters only on steel, the parameters are believed to transfer to nickel-based superalloy substrates and cobalt-based superalloy substrates in applications such as described above and below.

After heat treating, the friction becomes significantly more stable for both the RT and 300° C. test conditions. At room temperature, a break-in period of high friction is observed, which can be correlated with the breakage of the initial asperities caused by the heat treatment. The friction coefficient is lower for samples tested at 300° C. after the heat treatment.

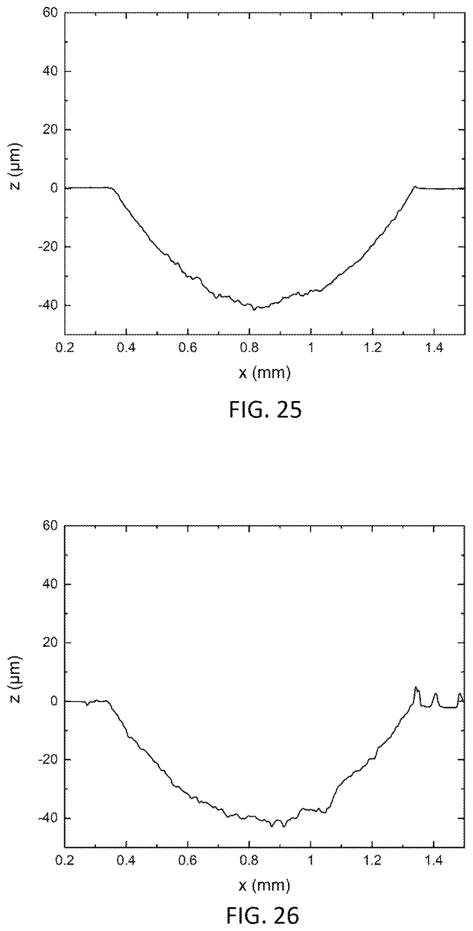

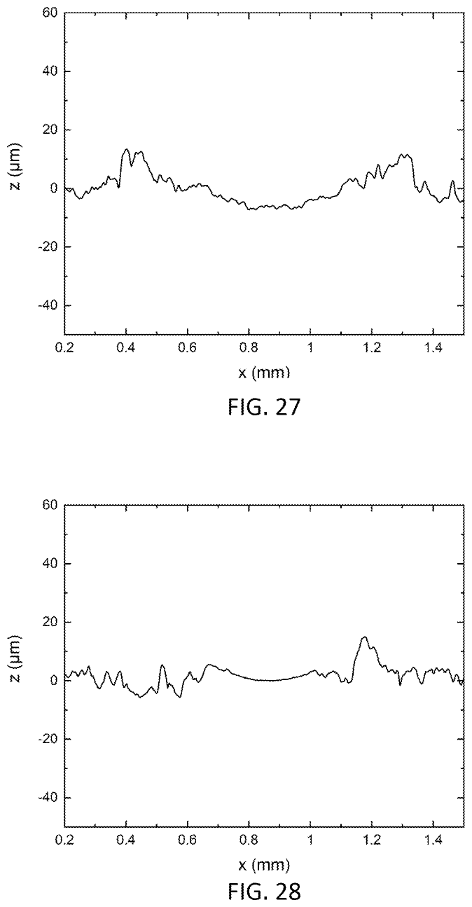

At room temperature and at 300° C. the coatings tested in the as sprayed condition (without any heat treatment) already shows lower wear rates than the bare substrate, showing a wear rate in the mid 10⁻⁴ mm³/N·m range at room temperature and at 300° C. degrees. A wear depth of almost 40 μm is observed for both test conditions, as shown in FIGS. 25-28.

After the heat treatment at 1040° C., the wear depth is greatly reduced both at room temperature and at 300° C. testing conditions. The wear track is almost as wide as the coating tested at room temperature, but significantly shallower, indicating that less material was removed. At 300° C., the track not only get shallower but also narrower. For this sample, the wear depth was in the same order of magnitude of the surface features (roughness). We believe polishing the sample before wear testing (to reduce the surface roughness) will increase wear rates, because the beneficial/protective oxides formed during the heat treatment will be removed during the grinding and polishing steps.

The results show the feasibility of producing coatings that will react and oxidize at high temperature forming ternary oxides. Although the coatings were heat treated to produce the oxide phases, it is likely that, once the coatings are subjected to high temperature wear tests, these oxides will be formed in a similar manner. Furthermore, it is expected that a further improvement might be achieved due to the formation of other in-situ ternary oxides once the testing temperature is further increased (e.g., above the current maximum testing temperature of 350° C.) when both mechanisms of formation (high temperature combined with mechanical mixing) will be active.

HV80 was also exposed to hot corrosion conditions, displaying better performance than the current state-of-the-art self-lubricating coatings (weight gain lower than 5 mg/cm² after 24-hours exposure to corrosive salts at all given temperatures), as shown in Table 3.

More generally, the MCrAlY is believed to provide temperature structural integrity. Example MCrAlY particle size is a 5-45 micrometer size distribution. This distribution is believed effective to work well in the higher velocity/lower temperature thermal spray domain.

The cobalt oxide, molybdenum oxide, and/or ternary phase oxide provides high temperature lubricity (e.g., at (400 to 900° C.). A ternary phase oxide is an oxide of two metals. In the example above, the ternary phase oxide is copper tantalate. A fluoride species (e.g., BaF₂ or CaF₂) provides lubricity over a large temperature range (e.g., 20 to 900° C.). A soft metal (e.g., Cu, Ag, Au, Pt) (e.g., below 110 HV) provides low temperature lubricity (e.g., 20 to 300° C.).

As is seen from this example, the copper may serve two roles. Oxidized copper may form part of the ternary phase oxide; whereas, unoxidized copper may serve as the soft metal providing low temperature lubricity. The oxidation may occur during heat treatment and/or in service. In such a case, oxides will be concentrated as a surface sub-layer potentially with a bulk of the coating below forming a layer that substantially represents the source material.

Regarding the high temperature lubricious oxide, there may be trade-offs particularly between cobalt and molybdenum. Thus, a lower cobalt concentration may favor a higher molybdenum concentration. An example combined cobalt and molybdenum concentration is 12.5% to 45.0%, by weight, more broadly 4.5% to 65%.

As noted above, an example use situation is a coating on the outer diameter (OD) surface of the substrate of a piston seal ring (PSR). Example PSR substrate material is nickel-based superalloy (e.g., wrought). Example, nickel-based superalloy legacy alloys are IN-718 (UNS N07718/W.Nr. 2.4668, Inconel® alloy 718 Huntington Alloys Corp., Huntington WV), X750 (UNS N07750/W. Nr. 2.4669, Inconel® alloy X750 Huntington Alloys Corp., Huntington WV), and Waspaloy (alloy 685, N07001). However, new alloys are continually being proposed. Example coating thickness is at least 50 micrometers, more particularly 50 micrometers to 250 micrometers or 50 micrometers to 200 micrometers or 75 micrometers to 125 micrometers. An example counterface is a mid turbine frame formed of a Ni-based alloy or superalloy (e.g., uncoated), such as Inconel® 718 (IN-718; UNS N07718; AMS 5662), Inconel® 100 (IN-100; UNS N13100; AMS 5397), and Inconel® 713C (IN-713C; Alloy 713C) each of (Huntington Alloys Corp., Huntington, WV) and Mar-M-247. However, new alloys are continually being proposed. An alternative example involves a PSR in an OD groove on a spool/rotor tie shaft with the primary counterface being the ID surface of a disk bore of that spool/rotor.

Another example is a sheetmetal static seal. For example, as in the '122 publication baseline, stainless steel or nickel- or cobalt-based superalloy or other seal substrates may be formed by deforming sheetmetal or may be cast or otherwise formed. On an axial compression seal such as a bellows seal or a W-seal, the present coating may be applied at least at axial ends of the seal. This may involve masking the remaining portions of the seal (e.g., via hard masking at the inner diameter and outer diameter boundaries of the seal) during the HVOF. However, other such seals may have a greater coating extent or a full coating extent.

Similarly, for radial compression seals, the ID and OD of the seal may be coated. Again, this coating may involve masking axial ends. However, particularly for C-seals, it may be desired to coat the entire outside of the C (the convex surface when viewed in central axial cross-section rather than the concave interior of the cross-section). For any of these, coating thickness may be similar to that described for the PSR.

Additionally, for either the PSR or the other seals, yet different substrate materials are possible. For example, it may be possible to use the present HEA coating on a seal having a different HEA substrate whose properties are chosen for purposes other than reduced wear and friction (e.g., thermal stability, fatigue resistance, and the like).

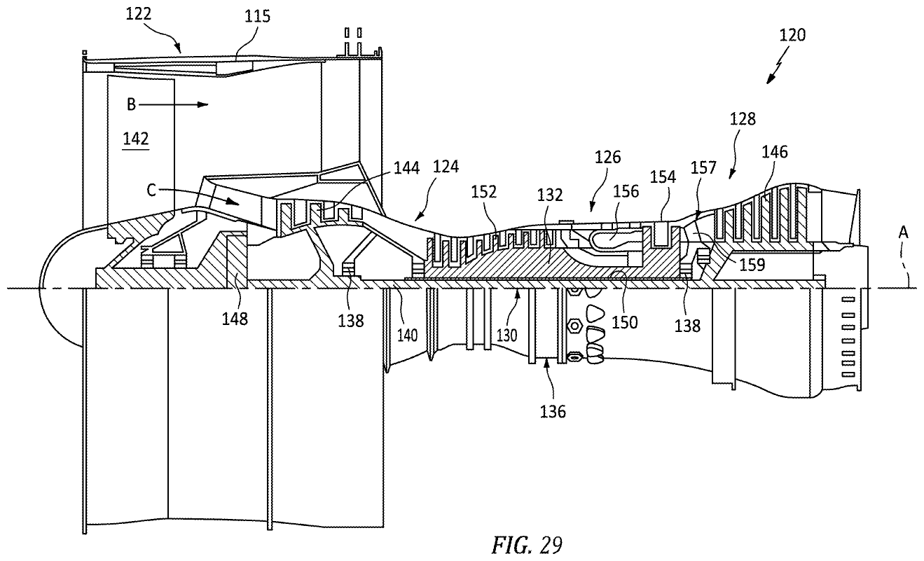

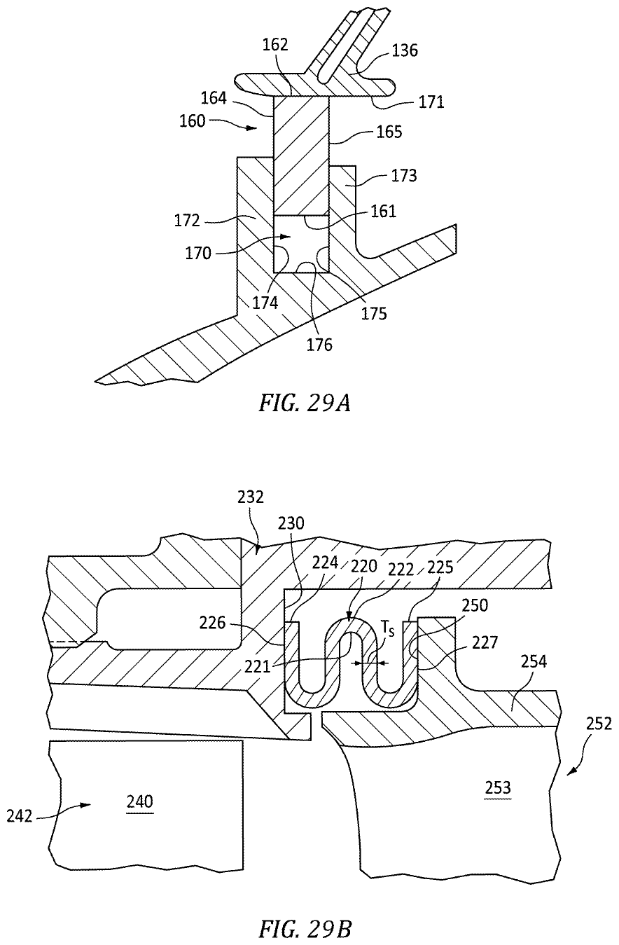

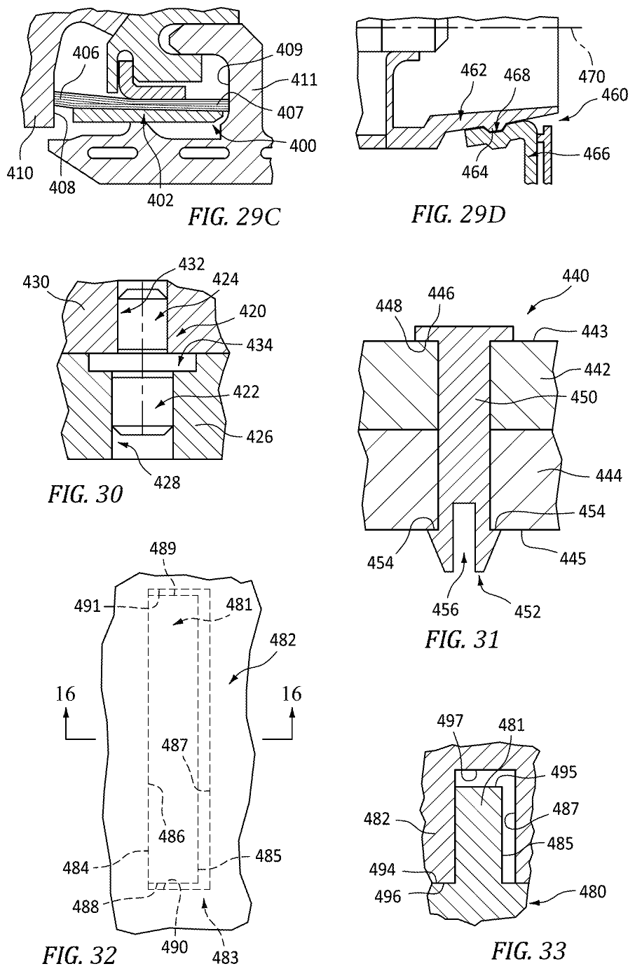

FIG. 29 schematically illustrates a gas turbine engine 120. The example gas turbine engine 120 is a two-spool turbofan that generally includes a fan section 122, a compressor section 124, a combustor section 126, and a turbine section 128. The fan section 122 drives air along a bypass flow path B in a bypass duct defined within a housing 115, such as a fan case or nacelle. The fan section also initially drives air along a core flow path C for compression through the compressor section and communication into the combustor section 126 then expansion through the turbine section 128. Although depicted as a two-spool turbofan gas turbine engine in the disclosed non-limiting embodiment, it should be understood that the concepts described herein are not limited to use with two-spool turbofans as the teachings may be applied to other types of turbine engines.

The example engine 120 generally includes a low speed spool 130 and a high speed spool 132 mounted for rotation about an engine central longitudinal axis A relative to an engine static structure 136 via several bearing systems 138. It should be understood that various bearing systems 138 at various locations may alternatively or additionally be provided, and the location of bearing systems 138 may be varied as appropriate to the application.

The low speed spool 130 generally includes an inner shaft 140 that interconnects, a first (or low) pressure compressor 144 and a first (or low) pressure turbine 146. The inner shaft 140 is connected to the fan 142 through a speed change mechanism, which in the example gas turbine engine 120 is illustrated as a geared architecture 148, to drive a fan 142 at a lower speed than the low speed spool 130. The high speed spool 132 includes an outer shaft 150 that interconnects a second (or high) pressure compressor 152 and a second (or high) pressure turbine 154. A combustor 156 is between the high pressure compressor 152 and the high pressure turbine 154. A mid-turbine frame 157 of the engine static structure 136 may be arranged generally between the high pressure turbine 154 and the low pressure turbine 146. The mid-turbine frame 157 further supports one or more of the bearing systems 138 in the turbine section 128. The inner shaft 140 and the outer shaft 150 are concentric and rotate via bearing systems 138 about the engine central longitudinal axis A which is collinear with their longitudinal axes.

The core airflow is compressed by the low pressure compressor 144 then the high pressure compressor 152, mixed and burned with fuel in the combustor 156, then expanded over the high pressure turbine 154 and low 146 pressure turbine. The example mid-turbine frame 157 includes airfoils 159 which are in the core airflow path C. The turbines 146, 154 rotationally drive the respective low speed spool 130 and high speed spool 132 in response to the expansion. It will be appreciated that each of the positions of the fan section 122, compressor section 124, combustor section 126, turbine section 128, and fan drive gear system 148 may be varied. For example, gear system 48 may be located aft of the low pressure compressor, or aft of the combustor section 26 or even aft of turbine section 128, and fan 142 may be positioned forward or aft of the location of gear system 48

FIG. 29A shows one example seal in the engine as a piston seal 160. The example seal 160 (and its metallic substrate) has an inner diameter (ID) surface 161, an outer diameter (OD) surface 162, and axial end surfaces 164 and 165. The seal follows a constant cross-sectional shape and forms a split ring with a shiplap or similar joint (not shown).

In the illustrated example, the piston seal 160 is partially accommodated in a radially outwardly open groove 170 in an inner member and its OD surface is engaged to an inner diameter (ID) surface 171 of an outer member. The example inner member is a vane structure (e.g., circumferential vane array) of the mid turbine frame 157. The example outer member is a seal runner of the static structure 136. The example groove is formed by the interior surfaces 174, 175 of wall sections 172, 173 and a base surface 176. The example walls have OD rims and outboard axial faces opposite the respective faces 174, 175.

Principal contact between the seal and the contacting members is between the seal OD surface 162 and the runner ID surface 171. Additional contact may be between the seal axial end surfaces and the adjacent groove wall surface. Wear and damage may occur at any of these. Typically, the counterface members nay be uncoated alloy at the interfaces (e.g., uncoated at the surfaces 171, 174, 175). Thus, the seal substrate surface at the seal OD and/or axial end faces (or the entire cross-sectional perimeter surface) may be coated as above.

Another example is a spring compression static seal. For example, as in the '122 publication baseline, stainless steel or nickel- or cobalt-based superalloy or other seal substrates may be formed by deforming sheetmetal or may be cast or otherwise formed. Example seals include axial compression seals such as a bellows seal or a W-seal, or for radial compression seals, such as C-seals or E-seals. For example, seal 220 (FIG. 29B) is a bellows or similar type seal with convoluted cross-section effective to be deformed under compression to self-spring-bias engagement with the counterface members. The cross-section generally has a generally inner diameter (ID) surface 221, a generally outer diameter (OD) surface 222 generally parallel and spaced apart from the ID surface by a material thickness Ts, and end surfaces 224 and 225. In an installed axially compressed state, axial ends 226, 227 of the seal are formed by portions of one of the surfaces 221, 222 (both 221 in the example). The illustrated seal is a W-seal although other configurations are possible (e.g., more or fewer cycles of the cross-sectional wave form) as are radial seals (e.g., an E-seal).

For the example seal 220, forward counterface members engaging the axial end 226 are a radially extending end surface portions 230 of a circumferential array of blade outer air seals (BOAS) 232. BOAS ID surfaces closely surround tips of airfoils 240 of a stage of blades 242. For the example seal 220, aft counterface members engaging the axial end are a radially extending end surface portions 250 of the OD shrouds 254 of a circumferential array of vanes 252. Example vanes are in clusters with multiple airfoils 253 per cluster.

In these example embodiments, wear may notably occur at counterface surfaces 171, 174, 175, 230, and 250. Each example counterface member (including other counterface member or other component (e.g., seal) discussed below to be coated) may be formed of a nickel- or cobalt-based based (e.g., largest by weight component Ni or Cr, respectively) alloy or superalloy (e.g., uncoated or coated), such as Inconel® 718 (IN-718; UNS N07718; AMS 5662), Inconel® 100 (IN-100; UNS N13100; AMS 5397)), and Inconel® 713C (IN-713C; Alloy 713C) each of (Huntington Alloys Corp., Huntington, West Virginia), Mar-M-247 and Haynes® 188 (UNS R30188) of Haynes International, Kokomo, Indiana. Thus, the seal substrate surface at least at the axial ends 226, 227 (forming contact surfaces) (or the entire cross-sectional perimeter surface) may be coated as above. In the seal relaxed/extended pre-installation condition, the areas to be coated may be other than axial ends (e.g., shifted along the surface 221).

Additional seal applications include brush seal systems, namely coating the brush seal counterface (e.g., runner). Typical brush seals have radially inwardly extending bristles engaging the OD surface of the counterface. U.S. Pat. No. 6,170,831B1 (the '831 patent), of Bouchard, Jan. 9, 2001, and entitled “Axial Brush Seal for Gas Turbine Engines”, the disclosure of which is incorporated by reference herein in its entirety as if set forth at length, discloses a double-ended axial static brush seal system partially re-presented as 400 in FIG. 29C. The brush 402 has two protruding bristle sections 406, 407 (e.g., of a single cluster of bristles) engaging respective counterfaces (a case segment and a blade outer air seal segment). FIG. 29C shows the coating may be applied by the present methods to the counterface surface 408, 409 of the counterface substrate 410, 411 to engage the bristles.

Other examples involve locating pins. A typical locating pin 420 (FIG. 30) has, forming opposite axial end sections of the pin, a base section or shank 422 for press-fit or threading into a hole or socket 428 in a first component 426 and a head 424 for accommodation in a hole or socket 432 of a second component 430. A flange 434 (if present) may separate the base or shank from the head. The head will typically have a tapered portion for guidance into the receiving socket 432. With a press-fit pin, the OD surface of the press-in base or shank may be coated by the present methods. Additionally, the head and flange faces may be coated. With a threaded pin, it is more likely that only the flange and head may be coated and not the threaded shank.

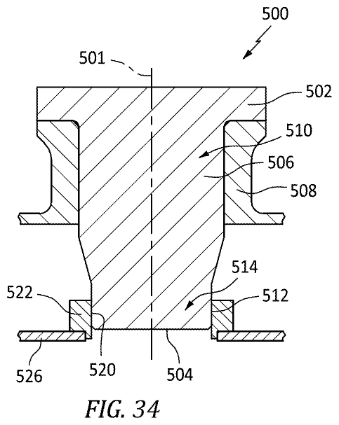

FIG. 34 shows an alternate locating pin joint having a locating pin 500. FIG. 17 shows the joint and pin as having a common axis 501. Forming a first/proximal end of the pin in this example is a head or terminal flange 502. A shaft generally extends from an underside of the head to a distal end 504. A proximal portion 506 of the shaft mounts to a first component 508. An example first component is an engine case. An example mounting is via press-fit or threading into a boss of the case either directly or to an insert in the boss. In this example, the shaft exterior surface 512 along a proximal portion 510 of the shaft is so externally threaded to mate with an internal thread of the case boss or insert.

Along a distal end portion 514 of the shaft, the shaft exterior surface 512 is in sliding engagement with a second component. An example engagement is with the inner diameter surface 520 of a boss 522 of the second component acting as a socket for said pin distal end portion. In the example, the second component is an annular combustion chamber liner 526 held spaced apart from the case (e.g., radially inward). The boss may be separately formed from and welded to a main section of the liner. Example wearing movement is between the OD surface 512 and ID surface 520. Relative movement is parallel to the axis 501 and typically results from differential thermal expansion and engine vibration. Thus, one or both of these surfaces (surface 512 along the distal portion and surface 520) may be coated via the present methods.

Another snap example is a separate snap fastener 440 (FIG. 31) (e.g., holding two (or more) generally flat sections (pieces) of material 442 and 444 against each other as if a rivet). In one example, the fastener has a head 446 with an underside 448 against the outer face 443 of one terminal piece 442 of the stack of mated pieces. A shaft or shank 450 extends from the underside to a tip/end 452. Adjacent the tip, the shaft has a barbed backlocking surface 454 (underside) facing the head and backlocked against the outer face 445 of the opposite terminal piece 444 in a sandwich of two or more pieces. Example fasteners have longitudinally split areas near the tip allowing insertion through holes in the pieces with the insertion compressing the slot 456 to allow passage of the barbs 458 and then relaxing once the barbs pass out of engagement with the members so as to back lock surfaces 454 to 445. Due to the relatively higher engagement pressures along the barb undersides 454 versus the head underside, the barb underside region and transition to shank main body 456 is a particular area for coating. With the snap fastener, the shaft/shank main body may also be coated by the present methods to limit wear of the holes in the mated components.

Among additional locations for the coating are in snap fit interfaces 460 (FIG. 29D) (e.g., either fully backlocked or detented). One example of a snap fit between two components involving a bead and groove interaction for mounting a swirler is shown in U.S. patent Ser. No. 10/101,031B2 (the '031 patent), of Williams et al., Oct. 16, 2018, and entitled “Swirler Mount Interface for Gas Turbine Engine Combustor”, the disclosure of which is incorporated by reference herein in its entirety as if set forth at length. The '031 patent discloses an OD (relative to swirler/injector axis 470) projection or bead 464 on a swirler 462 captured in an ID groove 468 in a bulkhead support shell 466. The coating may be applied by the present methods to one or both of the inner member (e.g., swirler) and outer member (e.g., bulkhead support shell) at the bead or groove and adjacent contacting OD and ID surface regions respectively. Often, ease of spraying may make it easiest to just apply to the OD surface of the inner member. But, with a large diameter and relatively small axial extent, it may be easy to also have normal spray access to the bulkhead ID surface to coat both pieces.

Additional examples involve tabs 481 (FIGS. 32&33) of a first component 480 in slots 483 in a second component 482 For example, in many annular mounting situations, tabs may protrude radially (inward or outward depending on the situation) and be received in associated slots. Example such tabs have first and second axial end faces 484, 485 facing or contacting slot end faces 486 and 487 and tab circumferential end faces (ends) 488, 489 contacting or facing slot circumferential end faces (ends) 490, 491. Typically, pressure or spring loading will bias one axially facing face 484 of the tab against the adjacent axially facing face 486 of the slot. Particularly that axial end face of the tab may be coated via the present methods. But also, circumferential end faces will typically provide some locating function and may also be coated. Spray access makes it easier to coat the tab faces (with a normal angle of incidence than coating slot faces (where the angle will be more off normal). Also, in the FIG. 33 example, there may be contacting surfaces 494, 496 of the components 480, 482 respectively aside the tab proximal end (base/root) and slot open end (opening). these contacting surfaces may also be coated by the present methods. The example slot is shown as having a depth (or radial height in the radial tab example) to provide clearance between its base or outer end 497 and the distal end (tip) 495 of the tab when the surfaces 484 and 496 are locally contacting at the tab.

Additional seal applications include examples involving knife edge seals (not shown). A typical knife edge seal has hardened knife edges. Thus, the runner (usually an OD surface of an inner member but optionally an ID surface of an outer member) may be the counterface coated by the present methods. An example knife edge seal is shown in U.S. patent Ser. No. 10/167,729B2 (the '729 patent), of Aiello et al., Jan. 1, 2019, and entitled “Knife Edge with Increased Crack Propagation Life”, the disclosure of which is incorporated by reference herein in its entirety as if set forth at length.

Additional seal applications involve finger seals (e.g., of steel or other alloys discussed above). With finger seals, the contacting portions of the seals themselves and/or the counterface surface may be coated via the present methods. Example finger seals are shown in U.S. patent Ser. No. 10/094,389B2 (the '389 patent), of Chuong et al., Oct. 9, 2018, and entitled “Flow Diverter to Redirect Secondary Flow”, and U.S. Pat. No. 9,845,695B2 (the '695 patent), of Budnick et al., Dec. 19, 2017, and entitled “Gas Turbine Seal Assembly and Seal Support”, the disclosures of which are incorporated by reference herein in their entireties as if set forth at length.

Additional seal applications involve so-called HALO seals (not shown). One example is shown in U.S. patent Ser. No. 10/221,714B2 (the '714 patent), of Peters et al., Mar. 5, 2019, and entitled “Secondary Seal Device(s) with Alignment Tab(s)”, the disclosure of which is incorporated by reference herein in its entirety as if set forth at length. The ID surface of the HALO seal may be coated by the present methods as may be the OD surface of the inner member or shaft. Additionally, alignment or mounting tabs are typical in such seals and may be coated as noted above.

The coating and layer thickness, composition, and properties may be measured at a single location or across an area. Such area may be a total or continuous area (e.g., truly continuous or continuous ignoring features such as cooling hole outlets). With an area, that may be at all locations or an average (mean, median, or mode). A representative area is at least 1.0 square centimeters. Or, a representative area may be a fraction or percentage of a relevant area. For example, the relevant area may be the OD surface of the PSR or the contact surface of another seal or other component. An example percentage is at least 10% or at least 50% or at least 90% of said relevant area.

The use of “first”, “second”, and the like in the following claims is for differentiation within the claim only and does not necessarily indicate relative or absolute importance or temporal order. Similarly, the identification in a claim of one element as “first” (or the like) does not preclude such “first” element from identifying an element that is referred to as “second” (or the like) in another claim or in the description.

One or more embodiments have been described. Nevertheless, it will be understood that various modifications may be made. For example, when applied to an existing baseline configuration, details of such baseline may influence details of particular implementations. Accordingly, other embodiments are within the scope of the following claims.

What is claimed is:

1. A method for applying a coating, the method comprising:
providing a mixture of: MCrAlY; Cu; Mo; and BaF₂ powders; and
spraying the mixture on a metallic substrate.

2. The method of claim 1 wherein the mixture further comprises:
Cr₂O₃ powder.

3. The method of claim 1 wherein:
the spraying is HVOF, HVAF, or cold spray.

4. The method of claim 1 wherein:
the spraying is HVOF spraying.

5. The method of claim 1 wherein:
the MCrAlY is a NiCoCrAlY or CoNiCrAlY.

6. The method of claim 5 wherein:
the mixture has a combined content said Mo and the Co of said MCrAlY of 12.5 weight percent to 45.0 weight percent.

7. The method of claim 1 wherein:
the MCrAlY is a NiCoCrAlTaY.

8. The method of claim 7 wherein the NiCoCrAlTaY comprises by weight percent:
Ni as a largest by weight constituent;
20.0 to 26.0 Co;
18.0 to 23.0 Cr;
6.0 to 11.0 Al;
2.0 to 6.0 Ta; and
0.3 to 0.9 Y.

9. The method of claim 7 wherein the NiCoCrAlTaY comprises by weight percent:
20.0 to 26.0 Co;
18.0 to 23.0 Cr;
6.0 to 11.0 Al;
2.0 to 6.0 Ta;
0.3 to 0.9 Y;
balance Ni plus impurities.

10. The method of claim 7 wherein the NiCoCrAlTaY comprises by weight percent:
16.0 to 26.0 Co;
15.0 to 23.0 Cr;
5.0 to 14.0 Al;
up to 9.0 Ta;
0.2 to 0.9 Y;
balance Ni plus up to 5.0 other total and 1.0 each other individually.

11. The method of claim 1 wherein the mixture comprises by weight:
20% to 80% MCrAlY;
2.5% to 20% Cu;
2.5% to 10% Mo;
2.5% to 10% BaF₂; and
up to 60% Cr₂O₃.

12. The method of claim 1 wherein the mixture comprises by weight:
0% to 60% Cr₂O₃; and
no more than 5.0% total other than the MCrAlY, Cu, Cr₂O₃, Mo, and BaF₂.

13. The method of claim 1 further comprising:
heat treating in an oxidizing atmosphere so as to form:
BaCrO₄;
BaMoO₄;
CuTa₂O₆;
Cu₂O; and
CuO.

14. The article of claim 1 wherein:
the substrate is a split ring seal substrate and the spraying is at least to an outer diameter surface of the substrate; or
the substrate is a spring compression seal substrate and the spraying is at least to an outer an axial end surface portion of the substrate; or
the substrate is a HALO seal substrate and the spraying is to an inner diameter surface of the substrate; or
the substrate is a locating pin substrate and the spraying is to a base of the locating pin or a distal end section of the locating pin; or
or the substrate interfaces with a locating pin and the spraying is to a counterface surface for the locating pin; or
the substrate is a snap fastener substrate and the spraying is to a shaft and a barb underside; or
the substrate is of a component having a snap fit bead or groove and the spraying is to said bead or groove; or
the substrate is of a component having a tab and the spraying is to a face of the tab; or
the substrate is of a component having a seal counterface and the spraying is to the seal counterface.

15. A coated substrate wherein the coating is applied according to claim 1.

16. The coated substrate of claim 15 wherein:
the coating has an HV0.3 hardness of at least 260.

17. The coated substrate of claim 15 wherein:
the coating has a thickness of 100 micrometers to 700 micrometers.

18. The coated substrate of claim 15 wherein the substrate is a Ni-based alloy.

19. The coated substrate of claim 15 wherein the substrate forms a piston seal ring and the coating is on an outer diameter surface of the substrate.

20. A coated substrate comprising:
a metallic substrate; and
a coating on the metallic substrate comprising:
an MCrAlY matrix;
a soft metal;
a fluoride species; and
molybdenum.

21. The coated substrate of claim 20 wherein:
the coating has a combined content said molybdenum and, if any, cobalt of said MCrAlY of 12.5 weight percent to 45 weight percent.

22. A method for processing the coated substrate of claim 21 wherein:
said MCrAlY comprises 10 to 35 Co by weight; and
the method comprises heat treating to form a surface sublayer of the coating comprising oxides of: said Co: said molybdenum; barium and/or calcium from said fluoride species; and said soft metal.

23. The coated substrate of claim 20 wherein the coating comprises by weight percent:
2.5 to 10.0 said fluoride species being BaF₂;
2.5 to 10.0 said molybdenum;
20.0 to 80.0 said MCrAlY; and
2.0 to 20.0 said soft metal being copper.

24. The coated substrate of claim 20 wherein:
the substrate is a split ring seal substrate and the coating is at least on an outer diameter surface of the substrate; or
the substrate is a spring compression seal substrate and the coating is at least on an outer an axial end surface portion of the substrate; or
the substrate is a HALO seal substrate and the coating is at least on an inner diameter surface of the substrate; or
the substrate is a locating pin substrate and the coating is at least on a base of the locating pin; or
or the substrate interfaces with a locating pin and the coating is at least on a counterface surface for the locating pin; or
the substrate is a snap fastener substrate and the coating is at least on a shaft and a barb underside; or
the substrate is of a component having a snap fit bead or groove and the coating is at least on said bead or groove; or
the substrate is of a component having a tab and the coating is at least on a face of the tab; or
the substrate is of a component having a seal counterface and the coating is at least on the seal counterface.

25. A coated substrate comprising:
a metallic substrate; and
a coating on the metallic substrate and having at least a surface layer comprising:
an MCrAlY matrix;
BaCrO₄ and/or CaCrO₄;
BaMoO₄ and/or CaCrO₄;
CuTa₂O₆;
Cu₂O;
CuO; and
Ni₃Al precipitates.
